(19) United States
(12) Patent Application Publication
(10) Pub. No.: US 2023/0416650 A1
(43) Pub. Date: Dec. 28, 2023

(54) DISHWASHING DETERGENT COMPOSITION COMPRISING XYLANASE AND BLOCK CO-POLYMER

(71) Applicant: The Procter & Gamble Company, Cincinnati, OH (US)

(72) Inventors: Lindsay Suzanne Bewick, Whitley Bay (GB); Neil Joseph Lant, NEWCASTLE UPON TYNE (GB); Ana L. Morales Garcia, Newcastle Upon Tyne (GB); Hamish Chun Lam Yau, Newcastle Upon Tyne (GB)

(21) Appl. No.: 18/325,470

(22) Filed: May 30, 2023

(30) Foreign Application Priority Data
Jun. 1, 2022 (EP) 22176773.4

(51) Int. Cl. C11D 3/386; C11D 11/00; C11D 3/37

(52) U.S. Cl. CPC C11D 3/38636; C11D 11/0023; C11D 3/3707; C11D 3/378

(57) ABSTRACT

A dishwashing detergent composition includes xylanase and an ethylene oxide-propylene oxide block copolymer having a cloud point of about 20° C. or greater than about 20° C.

### REFERENCE TO AN ELECTRONIC SEQUENCE LISTING

The contents of the electronic sequence listing (CM05461F-Sequence_Listing.xml; Size: 2,174 bytes; and Date of Creation: Aug. 29, 2023) is herein incorporated by reference in its entirety.

### TECHNICAL FIELD

The present disclosure is in the field of dishwashing, particularly automatic dishwashing. In particular, the present disclosure provides a dishwashing detergent composition that comprises a xylanase and a block co-polymer. The dishwashing detergent composition is particularly effective in removing burnt on baked on soil from soiled dishware during a dishwashing process.

### BACKGROUND

Dishwashing detergent formulators need to formulate their detergent compositions such that they provide numerous different benefits. A good cleaning profile and a good shine profile are two such very important benefits. When ensuring a good cleaning profile, the detergent formulators need to account for many different soils that will need to be removed from the soiled dishware. One very difficult soil to remove from soiled dishware is burnt on baked on soil. In addition to the types of soil, the detergent formulators also need to account for other factors, such as the dishwashing process used and the type of soiled dishware to be cleaned. Burnt on baked on soil is particularly difficult to remove during an automatic dishwashing process, that is typically carried out in an automatic dishwashing appliance. Furthermore, burnt on baked on soils are also difficult to remove from certain types of soiled dishware, such as soiled stainless steel dishware.

The present disclosure overcomes these above problems by providing a dishwashing detergent composition comprising a xylanase and a particular block co-polymer.

### SUMMARY

The present disclosure provides a dishwashing detergent composition comprising a xylanase and a ethylene oxide-propylene oxide block copolymer having a cloud point of 20° C. or greater than 20° C.

### DETAILED DESCRIPTION

The present disclosure provides a dishwashing detergent composition comprising a xylanase and a ethylene oxide-propylene oxide block copolymer having a cloud point of 20° C. or greater than 20° C.

Suitable xylanases are described in more detail below.

Suitable block co-polymers are described in more detail below.

### Xylanase

Typically, suitable xylanases have enzymatic activity against a xylan substrate, more typically an azo-arabinoxylan substrate. Typically, suitable xylanases provide values of at least OD₅₉₀ 0.2 absorbance units, more preferably at least 0.3 absorbance units and more preferably at least 0.5 units, when assayed for xylanase activity against an azo-arabinoxylan according to the method described in more detail below.

Suitable xylanases typically have endo-1,4-β-D-xylanase activity.

### Method for Determining Xylanase Activity

An assay procedure to measure degradation of azo-arabinoxylan substrate (Megazyme, S-AWAXL) was used to determine xylanase activity. Briefly, 0.2 g of powdered substrate was added to 20 mL volume of deionised water. 10 PPM of enzymes were incubated with 200 μl of the reconstituted xylan substrate in 2 ml eppendorf tubes for the activity assay.

Enzyme-substrate mixtures were incubated at 40° C. for 10 minutes in a thermomixer (Eppendorf), before terminating reactions by adding 1 ml of 95% ethanol, with vortexing. Reaction products were obtained by centrifuging samples at 1,500 g in a benchtop centrifuge for 10 min.

The absorbance of supernatant solutions at 590 nm were measured to determine enzyme activity. Under the conditions tested, an enzyme was defined as having xylanase activity by providing values of at least OD₅₉₀ 0.2 absorbance units, more preferably at least 0.3 absorbance units and more preferably at least 0.5 units.

A suitable xylanse is the wildtype enzyme of Bacillus agaradhaerens, Suitable xylanases have an amino acid sequence having at least 80%, or at least 85%, or at least 90%, or at least 95%, or at least 96%, or at least 97%, or at least 98%, or even at least 99% identity to the wildtype enzyme of Bacillus agaradhaerens.

Bacillus agaradhaerens is also known as Salipaludibacillus agaradhaerens.

A suitable xylanase has an amino acid sequence according to sequence ID no. 1. Sequence ID no. 1 is shown below:

MRQKKLTFILAFLVCFALTLPAEIIQAQIVTDNSIGNHDGYDYEFWKDS
GGSGTMILNHGGTFSAQWNNVNNILFRKGKKFNETQTHQQVGNMSINYG
ANFQPNGNAYLCVYGWTVDPLVEYYIVDSWGNWRPPGATPKGTITVDGG
TYDIYETLRVNQPSIKGIATFKQYWSVRRSKRTSGTISVSNHFRAWENL
GMNMGKMYEVALTVEGYQSSGSANVYSNTLRINGNPLSTISNDKSITLD
KNN

Suitable xylanases have an amino acid sequence having at least 80%, or at least 85%, or at least 90%, or at least 95%, or at least 96%, or at least 97%, or at least 98%, or even at least 99% identity to sequence ID no. 1.

“Percent sequence identity” means that a particular sequence has at least a certain percentage of amino acid residues identical to those in a specified reference sequence, when aligned using software programs such as the CLUSTAL W algorithm with default parameters. See Thompson et al. (1994) Nucleic Acids Res. 22:4673-4680. Default parameters for the CLUSTAL W algorithm are:

| | |
|---|---|
| Gap opening penalty: | 10.0 |
| Gap extension penalty: | 0.05 |
| Protein weight matrix: | BLOSUM series |
| DNA weight matrix: | IUB |
| Delay divergent sequences %: | 40 |
| Gap separation distance: | 8 |
| DNA transitions weight: | 0.50 |
| List hydrophilic residues: | GPSNDQEKR |
| Use negative matrix: | OFF |
| Toggle Residue specific penalties: | ON |
| Toggle hydrophilic penalties: | ON |
| Toggle end gap separation penalty | OFF |

Deletions are counted as non-identical residues, compared to a reference sequence.

The xylanase may preferably be of microbial origin, preferably of fungal (e.g., Trichoderma, Meripilus, Humicola, Aspergillus, Fusarium) or bacterial (e.g., Bacillus) origin. In a preferred embodiment the xylanase is a xylan degrading alkaline enzyme that can be produced as the wild type by alkalophilic; micro-organisms, but also the genes encoding the xylan degrading alkaline enzymes can be cloned and expressed in suitable hosts. Typically, the cloned xylan degrading alkaline enzymes are either the natural wild types or the protein engineered enzymes for improved compatibility with detergents. If the xylanase is a variant of a parent amino acid sequence, the parent may be obtained from a microorganism of any genus. For purposes of the present disclosure, the term “obtained from” as used herein in connection with a given source shall mean that the parent encoded by a polynucleotide is produced by the source or by a cell in which the polynucleotide from the source has been inserted. In one aspect, the parent is secreted extracellularly. Variants may be prepared using any mutagenesis procedure known in the art, such as site-directed mutagenesis, synthetic gene construction, semi-synthetic gene construction, random mutagenesis, shuffling, etc.

The xylanase may be from any glycoside hydrolase (Gi) family including GH5, GH7, GH8, GH110 GH-111, GH-116, GH-143, GH52 and GH62. Preferably the xylanase is from GH-110 or GH11. Most preferably the xylanase is from GH family 11.

The xylanase may be in the form of a liquid or a dry composition. For instance, the composition may be in the form of a granulate or a microgranulate. The xylanase may be stabilized including by encapsulation, in accordance with methods known in the art.

Preferably the xylanase is present in the wash in an amount of from 0.01 ppm to 1000 ppm of the enzyme, or from 0.05 or from 0.1 ppm to 750 or 500 ppm.

The xylanase may be one xylanase or a combination more than one xylanase, such as two or more different xylanases.

### Dishwashing Process

Any suitable dishwashing process can be used. A suitable dishwashing process is an automatic dishwashing process, such as an automatic dishwashing process that is carried out in an automatic dishwashing appliance, especially a domestic automatic dishwashing appliance.

The dishwashing process usually involves a dishwashing detergent composition, preferably an automatic dishwashing detergent composition.

The term “automatic dishwashing detergent composition” as used herein means a dishwashing composition to be used in dishwashing machine.

“Dishware” herein means cookware, dishware and tableware, i.e. all items related to cooking and serving food and drinks that are usually washed in a dishwasher.

As used herein, the articles including “a” and “an” are understood to mean one or more of what is claimed or described. Unless otherwise noted, all component or composition levels are in reference to the active portion of that component or composition, and are exclusive of impurities, for example, residual solvents or by-products, which may be present in commercially available sources of such components or compositions. Unless specifically stated or the context otherwise requires, embodiments described herein apply equally to all aspects of the present disclosure. Percentages quoted are by weight, unless otherwise stated or the context otherwise requires.

All measurements are performed at 25° C. unless otherwise specified.

### Ethylene Oxide-Propylene Oxide Block Copolymer

The ethylene oxide-propylene oxide block copolymer has a cloud point of 20° C. or greater than 20° C., preferably 21° C. or greater than 21° C., or preferably 22° C. or greater than 22° C.

Preferably, the ethylene oxide-propylene oxide triblock has a cloud point lower than 50° C., preferably lower than 40° C.

Preferably, the ethylene oxide-propylene oxide block copolymer is a triblock copolymer. Preferably the ethylene oxide-propylene oxide block copolymer is a triblock copolymer having one of the following structures:

EOx1 POy1 EOx2 (I)

POy2 EOx3 POy3 (II)

wherein each of x1, x2 and x3 is independently in the range of from 1 to 50, and each of y1, y2 and y3 is independently in the range of from 10 to 70.

The ethylene oxide-propylene oxide-ethylene oxide triblock copolymer of Formula I preferably has an average propylene oxide chain length of between 10 and 70, preferably between 20 and 60, more preferably between 25 and 55 propylene oxide units.

The ethylene oxide-propylene oxide-ethylene oxide triblock copolymer of Formula II preferably has an average ethylene oxide chain length of between 1 and 50, preferably between 2 and 40, more preferably between 3 and 30 ethylene oxide units.

Preferably, the ethylene oxide-propylene oxide triblock copolymer has a weight average molecular weight of between about 1000 and about 10,000 Daltons, preferably between about 1200 and about 8000 Daltons, more preferably between about 1500 and about 7000 Daltons, even more preferably between about 1750 and about 5000 Daltons, most preferably between about 2000 and about 4000 Daltons.

Suitable ethylene oxide-propylene oxide triblock copolymers are commercially available under the Pluronic PE and Pluronic RPE series from the BASF company, or under the Tergitol L series from the Dow Chemical Company. Particularly suitable materials are Pluronic PE 9200, Tergitol L81, Tergitol L62, Tergitol L61, Pluronic RPE 3110 and Pluronic RPE 2520.

The composition preferably comprises surfactants in addition to the block co-polymer.

### Method of Measuring the Cloud Point

The cloud point temperature can be determined as follows: a solution containing 1% of the corresponding material (e.g. the block co-polymer) by weight of the solution is prepared in distilled water. The solution is stirred gently before analysis to ensure that the process occurs in chemical equilibrium. The cloud point temperature is taken in a thermostatic bath by immersing the solution in a 75 mm sealed glass test tube. To ensure the absence of leakage, the test tube is weighed before and after the cloud point temperature measurement. The temperature is gradually increased at a rate of less than 1° C. per minute, until the temperature reaches a few degrees below the pre-estimated cloud point. The cloud point temperature is determined visually at the first sign of turbidity.

### Sulphonated Carboxylate Polymer

Suitable sulphonated carboxylate polymer can be used in any suitable amount, typically from about 0.1% to about 30%, preferably from 0.5% to about 20%, more preferably from 1% to 15% by weight of the composition.

Suitable sulphonated carboxylate polymers may have a weight average molecular weight of less than or equal to about 100,000 Da, or less than or equal to about 75,000 Da, or less than or equal to about 50,000 Da, or from about 3,000 Da to about 50,000, preferably from about 5,000 Da to about 45,000 Da.

Preferred sulphonated monomers include one or more of the following: 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxy-propanesulfonic acid, allylsulfonic acid, methallylsulfonic acid, 3-allyloxy-2-hydroxypropanesulfonic acid (salt) (HAPS), allyloxybenzenesulfonic acid, methallyloxybenzenesulfonic acid, 2-hydroxy-3-(2-propenyloxy) propanesulfonic acid, 2-methyl-2-propen-1-sulfonic acid, styrenesulfonic acid, vinylsulfonic acid, 3-sulfopropyl, 3-sulfo-propylmethacrylate, sulfomethacrylamide, sulfomethylmethacrylamide and mixtures of said acids or their water-soluble salts.

Preferably, the sulphonate carboxylate polymer comprises the following levels of monomers: from about 40 to about 90%, preferably from about 60 to about 90% by weight of the polymer of one or more carboxylic acid monomer; from about 5 to about 50%, preferably from about 10 to about 40% by weight of the polymer of one or more sulphonic acid monomer; and optionally from about 1% to about 30%, preferably from about 2 to about 20% by weight of the polymer of one or more non-ionic monomer. An especially preferred polymer comprises about 70% to about 80% by weight of the polymer of at least one carboxylic acid monomer and from about 20% to about 30% by weight of the polymer of at least one sulphonic acid monomer.

Typically, all or some of the carboxylic or sulphonic acid groups can be present in neutralized form, i.e. the acidic hydrogen atom of the carboxylic and/or sulphonic acid group in some or all acid groups can be replaced with metal ions, preferably alkali metal ions and in particular with sodium ions.

The carboxylic acid monomer can be (meth)acrylic acid. The sulphonic acid monomer can be 2-acrylamido-2-propanesulfonic acid (AMPS).

A suitable sulphonated carboxylate polymer is a sulphonated maleic/acrylic polymer. The sulphonic acid monomer can be 3-allyloxy-2-hydroxypropanesulfonic acid (salt) (HAPS).

A preferred sulphonated carboxylate polymer is a sulphonated acrylic polymer. A preferred sulphonated carboxylate polymer is a sulphonated acrylic polymer where the sulphonic acid monomer is 2-acrylamido-2-propanesulfonic acid (AMPS).

A preferred sulphonated carboxylate polymer is a sulphonated acrylic polymer. A preferred sulphonated carboxylate polymer is a sulphonated acrylic polymer where the sulphonic acid monomer is 2-acrylamido-2-propanesulfonic acid (AMPS).

Suitable commercially available sulphonated carboxylate polymers include: Alcosperse 240 and Aquatreat AR 540 supplied by Nouryon; Acumer 3100, Acumer 2000, Acusol 587G and Acusol 588G supplied by Dow; and Aqualic-GT-101 supplied by Nippon Shokubai. Particularly preferred polymers are Acusol 587G and Acusol 588G supplied by Dow.

The composition may comprise other (additional) polymers.

### Other Suitable Ingredients

### Surfactant Mixture

A ternary mixture of non-ionic surfactant can be included in the compositions. Compositions comprising this mixture have been found to exhibit good grease suspension, even at low temperatures, and drying properties especially on items treated in a dishwashing operation.

The compositions may comprise a ternary surfactant mixture comprising; a) a non-ionic surfactant having a cloud point of 50° C. or above (herein referred to as “high cloud point non-ionic surfactant”), and b) a non-ionic surfactant having a cloud point below 50° C. (herein referred to as “low cloud point non-ionic surfactant”), wherein the weight ratio of a) to b) is preferably in the range of from 2:1 to 1:2. The ternary surfactant mixture may further comprises an ethylene oxide-propylene oxide triblock copolymer having a cloud point below 50° C., preferably below 40° C.

The cloud point is the temperature at which a non-ionic surfactant solution phase separates into a water rich and surfactant rich phase and becomes cloudy. The cloud point temperature can be determined visually by identifying at which temperature cloudiness occurs.

The cloud point temperature of a non-ionic surfactant can be determined as follows: a solution containing 1% of the corresponding non-ionic surfactant by weight of the solution is prepared in distilled water. The solution is stirred gently before analysis to ensure that the process occurs in chemical equilibrium. The cloud point temperature is taken in a thermostatic bath by immersing the surfactant solution in a 75 mm sealed glass test tube. To ensure the absence of leakage, the test tube is weighed before and after the cloud point temperature measurement. The temperature is gradually increased at a rate of less than 1° C. per minute, until the temperature reaches a few degrees below the pre-estimated cloud point. The cloud point temperature is determined visually at the first sign of turbidity.

It is preferred that the cloud point of the high cloud point non-ionic surfactant is in the range of from 55° C. to 85° C., more preferably 60° C. to 80° C. It is preferred that the cloud point of the low cloud point non-ionic surfactant is in the range of from 5° C. to 45° C., more preferably 8° C. to 35° C.

According to the present disclosure it is most preferred that the high cloud point nonionic surfactant has a cloud point in the range of from 60° C. to 80° C. and the low cloud point nonionic surfactant has a cloud point in the range of from 8° C. to 35° C. Particularly good results have been achieved according to the present disclosure by compositions comprising a non-ionic surfactant mixture, wherein the high cloud point non-ionic surfactant is an alkoxylkated non-ionic surfactant having a single alkoxylate type, and the low cloud point non-ionic surfactant is an alkoxylkated non-ionic surfactant having at least two alkoxylate types.

The alkoxylated non-ionic surfactants of high cloud point may be prepared by the reaction of a monohydroxy alkanol or alkylphenol with 6 to 22 carbon atoms, preferably 8 to 20 carbon atoms, most preferably 10 to 18 carbon atoms. It is preferred that the type of alkoxylate surfactant is ethoxylate, butoxylate or propoxylate with ethoxylate being especially preferred. Preferably the high cloud point surfactants have 3 to 20 moles, particularly preferred 4 to 10 moles, and still more preferred 5 to 8 moles of alkylene oxide, particularly ethylene oxide, per mole of alcohol or alkylphenol. A particularly preferred high cloud point non-ionic surfactant is C10-C15 with 5-10 EO, more preferably C13 with 7EO. The high cloud point non-ionic surfactants may be prepared from either branched or linear chain fatty alcohols of the above types.

Preferred examples of high cloud point non-ionic surfactants are Lutensol T07 (BASF), Marlipal 013/70 (Sasol), Imbentin-T/070 (Kolb), Emuldac AS-11 (Sasol) and Emuldac AS-20 (Sasol).

The alkoxylated non-ionic surfactants of low cloud point may be prepared by the reaction of a monohydroxy alkanol or alkylphenol with 4 to 25 carbon atoms, preferably 6 to 20 carbon atoms, most preferably 8 to 14 carbon atoms. It is preferred that the low cloud point surfactant has 2 to 45 moles in total of alkylene oxide per mole of surfactant. It is preferred that the type of alkoxylates in low cloud point surfactant is a mixture of at least two of ethoxylate, butoxylate and/or propoxylate, with a mixture of ethoxylate and propoxylate being especially preferred. Preferably the low cloud point surfactants have 2 to 25 moles, especially 5 to 20 moles of ethylene oxide per mole of alcohol or alkylphenol and 2 to 40 moles, more preferably 5 to 30 moles of propylene oxide per mole of alcohol or alkylphenol. A mixture of butylene oxide or propylene oxide is also possible. A particularly preferred low cloud point surfactant is C10-C12 with 10-20 EO and 10-20 PO. The low cloud point non-ionic surfactants may be prepared from either branched or linear chain fatty alcohols of the above types.

Low cloud point surfactants may also include surfactants which are ethoxylated and butoxylated mono-hydroxy alkanols or alkylphenols, which additionally comprises polyoxyethylene-polyoxypropylene block copolymer units. The alcohol or alkylphenol portion of such surfactants constitutes more than 30%, preferably more than 50%, more preferably more than 70% by weight of the overall molecular weight of the non-ionic surfactant.

Preferred examples of low cloud point non-ionic surfactants are Plurafac SLF-180 (BASF) and Ecosurf LFE-1410 (Dow).

The low cloud point surfactant is typically more hydrophobic than the high cloud point surfactant and the amounts and types of the two surfactants in the claimed mixture are preferably selected such that the foaming characteristics of the composition are controlled to within the desired range. For automatic dishwashing applications it is usual to desire low-foaming characteristics

It is especially preferred according to the present disclosure that the high cloud point non-ionic surfactant is an ethoxylated non-ionic surfactant and the low cloud point non-ionic surfactant is a mixed propoxylated-ethoxylated-propoxylated non-ionic surfactant.

The weight ratio of high cloud point to low cloud point non-ionic surfactant is preferably in the range 2:1 to 1:2, more preferably 1.5:1 to 1:1.5.

The composition may preferably be a phosphate-free cleaning composition. The composition is preferably free of anionic and cationic surfactants. The composition may comprise a complexing agent, a dispersant polymer, bleach, inorganic builder (preferably carbonate and/or silicate), enzymes, in particular protease and amylase enzymes, glass care agents, metal care agents, etc.

When the composition is a cleaning composition, it preferably has a pH as measured in 1% weight aqueous solution in distilled water at 20° C. of at least 10, more preferably at least 10.5.

### Complexing Agents

Complexing agents are materials capable of sequestering hardness ions, particularly calcium and/or magnesium.

The composition preferably comprises from 10% to 60%, preferably from 20% to 40%, more preferably from 20% to 35% by weight of the composition of a complexing agent selected from the group consisting of methylglycine-N,N-diacetic acid (MGDA), glutamic acid-N,N-diacetic acid (GLDA), iminodisuccinic acid (IDS), citric acid, aspartic acid-N,N-diacetic acid (ASDA) its salts and mixtures thereof. Especially preferred complexing agent for use herein is a salt of MGDA, in particular the trisodium salt of MGDA. Mixture of citrate and the trisodium salt of MGDA are also preferred for use herein. Preferably, the composition comprises from 15% to 40% by weight of the composition of the trisodium salt of MGDA.

### Inorganic Builder

The composition preferably comprises an inorganic builder. Suitable inorganic builders are selected from the group consisting of carbonate, silicate and mixtures thereof. Especially preferred for use herein are sodium carbonate and silicate. Preferably the composition comprises from 5 to 50%, more preferably from 10 to 40% and especially from 15 to 30% of sodium carbonate by weight of the composition.

### Polymer

The polymer, if present, is used in any suitable amount from about 0.1% to about 30%, preferably from 0.5% to about 20%, more preferably from 1% to 15% by weight of the composition. Sulfonated/carboxylated polymers are particularly suitable for the composition.

Suitable sulfonated/carboxylated polymers described herein may have a weight average molecular weight of less than or equal to about 100,000 Da, or less than or equal to about 75,000 Da, or less than or equal to about 50,000 Da, or from about 3,000 Da to about 50,000, preferably from about 5,000 Da to about 45,000 Da.

Preferred sulfonated monomers include one or more of the following: 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxy-propanesulfonic acid, allylsulfonic acid, methallylsulfonic acid, allyloxybenzenesulfonic acid, methallyloxybenzenesulfonic acid, 2-hydroxy-3-(2-propenyloxy) propanesulfonic acid, 2-methyl-2-propen-1-sulfonic acid, styrenesulfonic acid, vinylsulfonic acid, 3-sulfopropyl, 3-sulfo-propylmethacrylate, sulfomethacrylamide, sulfomethylmethacrylamide and mixtures of said acids or their water-soluble salts.

Preferably, the polymer comprises the following levels of monomers: from about 40 to about 90%, preferably from about 60 to about 90% by weight of the polymer of one or more carboxylic acid monomer; from about 5 to about 50%, preferably from about 10 to about 40% by weight of the polymer of one or more sulfonic acid monomer; and optionally from about 1% to about 30%, preferably from about 2 to about 20% by weight of the polymer of one or more non-ionic monomer. An especially preferred polymer comprises about 70% to about 80% by weight of the polymer of at least one carboxylic acid monomer and from about 20% to about 30% by weight of the polymer of at least one sulfonic acid monomer.

In the polymers, all or some of the carboxylic or sulfonic acid groups can be present in neutralized form, i.e. the acidic hydrogen atom of the carboxylic and/or sulfonic acid group in some or all acid groups can be replaced with metal ions, preferably alkali metal ions and in particular with sodium ions.

The carboxylic acid is preferably (meth)acrylic acid. The sulfonic acid monomer is preferably 2-acrylamido-2-propanesulfonic acid (AMPS).

Preferred commercial available polymers include: Alcosperse 240 and Aquatreat AR 540 supplied by Nouryon; Acumer 3100, Acumer 2000, Acusol 587G and Acusol 588G supplied by Dow. Particularly preferred polymers are Acusol 587G and Acusol 588G supplied by Dow.

Suitable polymers include anionic carboxylic polymer of low molecular weight. They can be homopolymers or copolymers with a weight average molecular weight of less than or equal to about 200,000 g/mol, or less than or equal to about 75,000 g/mol, or less than or equal to about 50,000 g/mol, or from about 3,000 to about 50,000 g/mol, preferably from about 5,000 to about 45,000 g/mol. The dispersant polymer may be a low molecular weight homopolymer of polyacrylate, with an average molecular weight of from 1,000 to 20,000, particularly from 2,000 to 10,000, and particularly preferably from 3,000 to 5,000.

The polymer may be a copolymer of acrylic with methacrylic acid, acrylic and/or methacrylic with maleic acid, and acrylic and/or methacrylic with fumaric acid, with a molecular weight of less than 70,000. Their molecular weight ranges from 2,000 to 80,000 and more preferably from 20,000 to 50,000 and in particular 30,000 to 40,000 g/mol. and a ratio of (meth)acrylate to maleate or fumarate segments of from 30:1 to 1:2.

The polymer may be a copolymer of acrylamide and acrylate having a molecular weight of from 3,000 to 100,000, alternatively from 4,000 to 20,000, and an acrylamide content of less than 50%, alternatively less than 20%, by weight of the dispersant polymer can also be used. Alternatively, such polymer may have a molecular weight of from 4,000 to 20,000 and an acrylamide content of from 0% to 15%, by weight of the polymer.

Polymers suitable herein also include itaconic acid homopolymers and copolymers.

Alternatively, the polymer can be selected from the group consisting of alkoxylated polyalkyleneimines, alkoxylated polycarboxylates, polyethylene glycols, styrene co-polymers, cellulose sulfate esters, carboxylated polysaccharides, amphiphilic graft copolymers and mixtures thereof.

### Enzymes

The composition preferably comprises enzyme in addition to the xylanase. More preferably amylases and proteases.

In describing enzyme variants herein, the following nomenclature is used for ease of reference: Original amino acid(s):position(s):substituted amino acid(s). Standard enzyme IUPAC 1-letter codes for amino acids are used.

### Proteases

Suitable proteases include metalloproteases and serine proteases, including neutral or alkaline microbial serine proteases, such as subtilisins (EC 3.4.21.62) as well as chemically or genetically modified mutants thereof. Suitable proteases include subtilisins (EC 3.4.21.62), including those derived from Bacillus, such as Bacillus lentus, B. alkalophilus, B. subtilis, B. amyloliquefaciens, Bacillus pumilus and Bacillus gibsonii.

Especially preferred proteases are polypeptides demonstrating at least 90%, preferably at least 95%, more preferably at least 98%, even more preferably at least 99% and especially 100% identity with the wild-type enzyme from Bacillus lentus, comprising mutations in one or more, preferably two or more and more preferably three or more of the following positions, using the BPN′ numbering system and amino acid abbreviations as illustrated in WO00/37627, which is incorporated herein by reference: V68A, N87S, S99D, S99SD, S99A, S101G, S101M, S103A, V104N/I, G118V, G118R, S128L, P129Q, S130A, Y167A, R170S, A194P, V205I and/or M222S.

Most preferably the protease is selected from the group comprising the below mutations (BPN′ numbering system) versus either the PB92 wild-type (SEQ ID NO:2 in WO 08/010925) or the subtilisin 309 wild-type (sequence as per PB92 backbone, except comprising a natural variation of N87S).
(i) G118V+S128L+P129Q+S130A
(ii) S101M+G118V+S128L+P129Q+S130A
(iii) N76D+N87R+G118R+S128L+P129Q+S130A+S188D+N248R
(iv) N76D+N87R+G118R+S128L+P129Q+S130A+S188D+V244R
(v) N76D+N87R+G118R+S128L+P129Q+S130A
(vi) V68A+N87S+S101G+V104N

Suitable commercially available protease enzymes include those sold under the trade names Savinase®, Polarzyme®, Kannase®, Ovozyme®, Everlase® and Esperase® by Novozymes A/S (Denmark), those sold under the tradename Properase®, Purafect®, Purafect Prime®, Purafect Ox®, FN3®, FN4®, Excellase®, Ultimase® and Purafect OXP® by Genencor International, those sold under the tradename Opticlean® and Optimase® by Solvay Enzymes, those available from Henkel/Kemira, namely BLAP.

Preferred levels of protease in the second composition include from about 0.2 to about 2 mg of active protease per grams of the composition.

### Amylases

The composition may comprise amylases. A preferred alkaline amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:
(a) the variants described in U.S. Pat. No. 5,856,164 and WO99/23211, WO 96/23873, WO00/60060 and WO 06/002643, especially the variants with one or more substitutions in the following positions versus the AA560 SEQ ID No. 3:
   9,26, 30, 33, 82, 37, 106, 118, 128, 133, 149, 150, 160, 178, 182, 186, 193, 195, 202, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, 484, preferably that also contain the deletions of D183* and G184*.
(b) variants exhibiting at least 95% identity with the wild-type enzyme from Bacillus sp.707 (SEQ ID NO:7 in U.S. Pat. No. 6,093,562), especially those comprising one or more of the following mutations M202, M208, S255, R172, and/or M261. Preferably said amylase comprises one of M202L or M202T mutations.

Suitable commercially available alpha-amylases include DURAMYL®, LIQUEZYME®, TERMAMYL®, TERMAMYL ULTRA®, NATALASE®, EVEREST®, SUPRAMYL®, STAINZYME®, STAINZYME PLUS®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS®, POWERASE®, EXCELLENZ™ S series, including EXCELLENZ™ S 1000 and EXCELLENZ™ S 2000 and PURASTAR OXAM® (DuPont Industrial Biosciences., Palo Alto, California) and KAM® (Kao, 14-10 Nihonbashi Kayabacho, 1-chome, Chuo-ku Tokyo 103-8210, Japan). Amylases especially preferred for use herein include NATALASE®, STAINZYME®, STAINZYME PLUS®, EXCELLENZ™ S 1000, EXCELLENZ™ S2000 and mixtures thereof.

Preferably, the composition comprises at least 0.005 mg, preferably from about 0.0025 to about 0.025, more preferably from about 0.05 to about 0.3, especially from about 0.01 to about 0.25 mg of active amylase.

Preferably, the protease and/or amylase of the composition are in the form of granulates, the granulates comprise more than 29% of sodium sulfate by weight of the granulate and/or the sodium sulfate and the active enzyme (protease and/or amylase) are in a weight ratio of between 3:1 and 100:1 or preferably between 4:1 and 30:1 or more preferably between 5:1 and 20:1.

### Crystal Growth Inhibitor

Crystal growth inhibitors are materials that can bind to calcium carbonate crystals and prevent further growth of species such as aragonite and calcite.

Especially preferred crystal growth inhibitor for use herein is HEDP (1-hydroxyethylidene 1,1-diphosphonic acid). Preferably, the composition comprises from 0.01 to 5%, more preferably from 0.05 to 3% and especially from 0.5 to 2% of a crystal growth inhibitor by weight of the composition, preferably HEDP.

### Bleach

The composition may comprise from about 8 to about 30%, more preferably from about 9 to about 25%, even more preferably from about 9 to about 20% of bleach by weight of the composition.

Inorganic and organic bleaches are suitable for use herein. Inorganic bleaches include perhydrate salts such as perborate, percarbonate, persulfate and persilicate salts. The inorganic perhydrate salts are normally the alkali metal salts. The inorganic perhydrate salt may be included as the crystalline solid without additional protection. Alternatively, the salt can be coated. Suitable coatings include sodium sulphate, sodium carbonate, sodium silicate and mixtures thereof. Said coatings can be applied as a mixture applied to the surface or sequentially in layers.

Alkali metal percarbonates, particularly sodium percarbonate is the preferred bleach for use herein. The percarbonate is most preferably incorporated into the products in a coated form which provides in-product stability.

Potassium peroxymonopersulfate is another inorganic perhydrate salt of utility herein.

Typical organic bleaches are organic peroxyacids, especially dodecanediperoxoic acid, tetradecanediperoxoic acid, and hexadecanediperoxoic acid. Mono- and diperazelaic acid, mono- and diperbrassylic acid are also suitable herein. Diacyl and Tetraacylperoxides, for instance dibenzoyl peroxide and dilauroyl peroxide, are other organic peroxides that can be used in the context of this present disclosure.

Further typical organic bleaches include the peroxyacids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, F-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

### Bleach Activators

Bleach activators are typically organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having preferably from 1 to 12 carbon atoms, in particular from 2 to 10 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), decanoyloxybenzoic acid (DOBA), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). If present the composition comprises from 0.01 to 5, preferably from 0.2 to 2% by weight of the composition of bleach activator, preferably TAED.

### Bleach Catalyst

The composition may contain a bleach catalyst, preferably a metal containing bleach catalyst. More preferably the metal containing bleach catalyst is a transition metal containing bleach catalyst, especially a manganese or cobalt-containing bleach catalyst. Bleach catalysts preferred for use herein include manganese triazacyclononane and related complexes; Co, Cu, Mn and Fe bispyridylamine and related complexes; and pentamine acetate cobalt(III) and related complexes.

The composition may comprise from 0.001 to 0.5, more preferably from 0.002 to 0.05% of bleach catalyst by weight of the composition. Preferably the bleach catalyst is a manganese bleach catalyst.

### Metal Care Agents

Metal care agents may prevent or reduce the tarnishing, corrosion or oxidation of metals, including aluminium, stainless steel and non-ferrous metals, such as silver and copper. Preferably the composition comprises from 0.1 to 5%, more preferably from 0.2 to 4% and specially from 0.3 to 3% by weight of the composition of a metal care agent, preferably the metal care agent is benzo triazole (BTA).

### Glass Care Agents

Glass care agents protect the appearance of glass items during the dishwashing process. Preferably the composition comprises from 0.1 to 5%, more preferably from 0.2 to 4% and especially from 0.3 to 3% by weight of the composition of a glass care agent, preferably the glass care agent is a zinc salt.

The composition may preferably be a rinse aid.

When the composition is a rinse aid, it preferably has a pH as measured in 1% weight/volume aqueous solution in distilled water at 20° C. of from less than 8, more preferably less than 7.5.

Preferably, the cleaning composition comprises:
i) from 5 to 50% by weight of the composition of a builder;
ii) from 0.5 to 10% by weight of the composition of detersive surfactant;
iii) from 5 to 50% by weight of the composition of a complexing agent, preferably the complexing agent comprises a salt of MGDA;
iv) xylanase and other enzymes, preferably an amylase and a protease;
v) optionally from 0.5 to 5% by weight of the composition of polymer;
vi) optionally from 5 to 20% by weight of the composition of bleach and more preferably a bleach catalyst;

### Hydrotropes

The rinse aid composition can include a hydrotrope. A hydrotrope creates increased water solubility of hydrophobic materials and ensures physical stability of the composition. In some embodiments, hydrotropes are low molecular weight aromatic sulfonate materials such as cumene sulfonate, xylene sulfonate and dialkyldiphenyl oxide sulfonate materials. In other embodiments, hydrotropes are short chainlength alkyl sulfates with less than 10 carbon atoms in the alkyl chain.

A hydrotrope or combination of hydrotropes can be present in the compositions at an amount of from between about 1% to about 50% by weight of the composition. In other embodiments, a hydrotrope or combination of hydrotropes can be present at about 10% to about 30% by weight of the composition.

### Carrier.

The rinse composition can be formulated as liquid compositions. Carriers can be included in such liquid formulations. Any carrier suitable for use in a rinse aid composition can be used in the present disclosure. For example, in some embodiments the compositions include water as a carrier.

In some embodiments, liquid rinse aid compositions according to the present disclosure will contain no more than about 98% by weight of the composition of water and typically no more than about 90% by weight of the composition of water. In other embodiments, liquid rinse aid compositions will contain at least 50% by weight of the composition of water, or at least 60% by weight of the composition of water as a carrier.

The rinse composition may comprise a pH regulator agent, glass care and/or metal care agents.

By “low temperature” is herein meant a program having a main wash temperature of 550 or below, preferably 45° C. or below, preferably 40° C. or below.

A domestic dishwasher can usually provide a plurality of programs, such as a basic wash program, for washing normally dirty dishware dried up to a certain extent; an intensive wash program, for washing very dirty dishware, or in case of food rests particularly difficult to remove (very dry or burnt spots); an economy wash program, for washing lightly dirty dishware or partial loads of dishware; fast wash program, for a washing like the previous cycle, should a faster washing of partial dishware loadings be wished. Each program comprises a plurality of sequential steps. Usually, one or two cold prewash cycles, a cleaning cycle (also known as main wash), a cold rinse cycle, a hot rinse cycle and optionally a drying cycle. During the different cycles of a program, different compositions can be added to the water in the dishwasher to help the cleaning. Preferably, the first composition is delivered into the pre-wash and the second composition into the main-wash cycle.

During the course of a selected dishwashing program a domestic dishwasher generally performs one or more cycles, such as a pre-wash, main-wash, intermediate rinse cycle, final rinse cycle and then a drying cycle to terminate the program. During the respective cycles, wash liquor is distributed, in particular sprayed, by means of a rotating spray arm, a fixed spray nozzle, for example a top spray head, a movable spray nozzle, for example a top spinning unit, and/or some other liquid distribution apparatus, in the treatment chamber of the dishwasher cavity, in which wash liquor is applied to items to be washed, such as dishes and/or cutlery, to be cleaned, which are supported in and/or on at least one loading unit, for example a pull-out rack or a cutlery drawer that can preferably be removed or pulled out. To this end the dishwasher is preferably supplied with wash liquor by way of at least one supply line by an operating circulating pump, said wash liquor collecting at the bottom of the dishwasher cavity, preferably in a depression, in particular in a sump. If the wash liquor must be heated during the respective liquid-conducting washing sub-cycle, the wash liquor is heated by means of a heating facility. This can be part of the circulating pump. At the end of the respective liquid-conducting washing sub-cycle some or all of the wash liquor present in the treatment chamber of the dishwasher cavity in each instance is pumped out by means of a drain pump.

The composition can be placed in a storage reservoir in the interior of the dishwasher, the reservoir may house a plurality of doses to be dispensed into a plurality of programs.

The reservoir containing the composition can be located inside or outside of the dishwasher. If placed inside of the dishwasher, the storage reservoir can be integrated into the automatic dishwasher (i.e., a storage reservoir permanently fixed (built in) to the automatic dishwasher), and can also be an autarkic (i.e., an independent storage reservoir that can be inserted into the interior of the automatic dishwasher).

An example of an integrated storage reservoir is a receptacle built into the door of the automatic dishwasher and connected to the interior of the dishwasher by a supply line.

A dosing device can be for example an automated unit comprising the storage reservoir and a dispensing unit capable of releasing a controlled amount of different compositions at different times, for example to the pre-wash and to the main-wash. Different types of hardware might be part of the dosing device for controlling the dispensing of the cleaning composition, or for communicating with external devices such as data processing units, the dishwasher or a mobile device or server that a user can operate.

The storage reservoir should have very good thermal stability, especially if it is to be located in the interior of the dishwasher.

Preferred processes according to the present disclosure are those wherein the compositions, prior to being metered into the interior of the dishwasher, remains in the storage reservoir that is located outside (as for example WO2019/81910A1) or inside of the dishwasher for at least two, preferably at least four, particularly preferably at least eight and in particular at least twelve separate dishwashing programs.

The dosing system can be linked to sensors that can determine, based on sensor's input, the amount of composition required. Sensors that may be used include pH, turbidity, temperature, humidity, conductivity, etc. The dishwasher may require data processing power to achieve this. It is preferred that the dishwashing will have connectivity to other devices. This may take the form of wi-fi, mobile data, blue tooth, etc. This may allow the dishwasher to be monitored and/or controlled remotely. Preferably, this also allows the machine to connect with the internet.

The volume of preferred storage reservoirs containing one or more chambers is from 10 to 1000 ml, preferably from 20 to 800 ml, and especially from 50 to 500 ml.

### Embodiments of the Present Disclosure

1. A dishwashing detergent composition comprising a xylanase and an ethylene oxide-propylene oxide block copolymer having a cloud point of 20° C. or greater than 20° C.
2. A composition according to embodiment 1, wherein the ethylene oxide-propylene oxide block copolymer is a triblock copolymer and can have one of the following structures:

EOx1 POy1 EOx2 (I)

POy2 EOx3 POy3 (II)
wherein each of x1, x2 and x3 is independently in the range of from 1 to 50, and each of y1, y2 and y3 is independently in the range of from 10 to 70.
3. A composition according to any preceding embodiment, wherein the dishwashing detergent composition comprises a sulphonated carboxylate polymer.
4. A composition according to embodiment 3, wherein the sulphonated carboxylate polymer is a sulphonated acrylic polymer and/or a sulphonated acrylic/maleic polymer.
5. A composition according to any preceding embodiment, wherein the dishwashing detergent composition is in the form of a unit dose pouch.
6. A composition according to any preceding embodiment, wherein the xylanase has an amino acid sequence having at least 90% identity to sequence ID no. 1.
7. A composition according to any of embodiments 1-5, wherein the xylanase is selected from glycosyl hydrolases from GH family 10 and/or 11.
8. A composition according to any preceding embodiment, wherein the dishwashing detergent composition comprises a bleach catalyst.
9. A composition according to any preceding embodiment, wherein the dishwashing detergent composition comprises a chelant.

### EXAMPLES

The following test was completed to compare the BOBO soil removal benefits of xylanase in different surfactant systems

### BOBO Soil Preparation

BOBO soil consisting of macaroni pasta (Kraft), margarine (I can't believe it's not butter, upfield), whole milk (Asda) and cheese powder (Kraft) was prepared by heating the mixture on a stove top and blending the mixture in a liquidiser, supplied by Dualit limited, UK. Soil mixtures were applied onto the centre of 3×3 cm stainless steel tokens and cooked in an oven (Genlab LTD) for 7 minutes at 204° C. Soils were left to set at ambient room temperature for two hours.

### Cleaning Method

Soil removal testing was conducted using soiled tokens in 6-well plates on an incubating rocking shaker, supplied by OHAUS corporation, USA.

The soiled tokens were incubated in wells containing 5 ml sodium carbonate buffered solution, 10 PPM of xylanase (Pulpzyme HC 2500, Novozymes), in the absence or presence of 0.15 g/L Pluronic PE9200 (BASF) respectively. Reactions were carried out for 90 minutes at 40° C., in city water containing 6.9 grains per gallon (gpg) hardness. Washed tokens were removed from their respective wells and dried at ambient room temperature overnight.

Once dry, soil removal from token surfaces was calculated by gravimetric analysis using weights of soiled tokens before and after washing. Percentage soil removal was calculated by dividing grams of soil removed, by grams of soil remaining, multiplied by 100. 6 external replicates were carried out for each test leg and mean differences vs. a leg containing xylanase only, were plotted with standard error.

Washing with a xylanase alone, delivered 20.64±0.29% BOBO soil removal (Example A) in the current test. Washing with a surfactant, Pluronic PE9200, alone delivered 4.33±0.25% soil removal. Washing with a xylanase in the presence of Pluronic PE9200, delivered an improved soil removal of 28.40±1.28%, which was greater than the sum of the benefit delivered by the xylanase and Pluronic PE9200 alone. This benefit was statistically significant to all the other test legs.

| | Soil | | | P-value vs |
|---|---|---|---|---|
| | removal ± | P-value vs | P-value vs | Pluronic |
| | SE (%) | Nil | Xylanase | PE9200 |
| Nil | 1.85 ± 0.23 | — | — | — |
| Xylanase | 20.64 ± 0.29 | 5.03 × 10⁻¹³ | — | — |
| Pluronic | 4.33 ± 0.25 | 2.59 × 10⁻⁵ | 1.70 × 10⁻¹² | — |
| PE9200 | | | | |
| Xylanase + | 28.40 ± 1.28 | 2.83 × 10⁻⁶ | 0.0014 | 4.53 × 10⁻⁶ |
| Pluronic | | | | |
| PE9200 | | | | |

### Example A—BOBO Soil Removal from Hard Surfaces by Xylanases in Combination with Surfactants. Mean±Standard Error is Shown for Each Test Leg (n=6)

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any present disclosure disclosed or claimed herein or that it alone, or in any combination with any other reference or references, teaches, suggests or discloses any such present disclosure. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this present disclosure.

What is claimed is:

1. A dishwashing detergent composition comprising a xylanase and an ethylene oxide-propylene oxide block copolymer having a cloud point of about 20° C. or greater than about 20° C.

2. The composition according to claim 1, wherein the ethylene oxide-propylene oxide block copolymer comprises a triblock copolymer and having one of the following structures:
EOx1 POy1 EOx2 (I)
POy2 EOx3 POy3 (II)
wherein each of x1, x2 and x3 is independently in the range of from about 1 to about 50, and each of y1, y2 and y3 is independently in the range of from about 10 to about 70.

3. The composition according to claim 1, further comprising a sulphonated carboxylate polymer.

4. The composition according to claim 3, wherein the sulphonated carboxylate polymer comprises a sulphonated acrylic polymer and/or a sulphonated acrylic/maleic polymer.

5. The composition according to claim 1, wherein the dishwashing detergent composition is in the form of a unit dose pouch.

6. The composition according to claim 1, wherein the xylanase has an amino acid sequence having at least about 90% identity to sequence ID no. 1.

7. The composition according to claim 1, wherein the xylanase is selected from glycosyl hydrolases from GH family 10 and/or 11.

8. The composition according to claim 1, further comprising a bleach catalyst.

9. The composition according to claim 1, further comprising a chelant.


SEQUENCE LISTING (1 sequence)

SEQ ID NO: 1 - protein, 248 aa, Bacillus agaradhaerens
MRQKKLTFILAFLVCFALTLPAEIIQAQIVTDNSIGNHDGYDYEFWKDSGGSGTMILNHGGTFSAQWNNVNNILFRKGKKFNETQTHQQVGNMSINYGANFQPNGNAYLCVYGWTVDPLVEYYIVDSWGNWRPPGATPKGTITVDGGTYDIYETLRVNQPSIKGIATFKQYWSVRRSKRTSGTISVSNHFRAWENLGMNMGKMYEVALTVEGYQSSGSANVYSNTLRINGNPLSTISNDKSITLDKNN